(19) United States
(12) Patent Application Publication
(10) Pub. No.: US 2007/0294728 A1
(43) Pub. Date: Dec. 20, 2007

(54) Method for Transmitting an Electronic Programme Guide Containing Previews and Corresponding Data Stream

(76) Inventors: Thierry Quere, Monfort sur Meu (FR); Sebastien Fraleu, Noyal sur Vilaine (FR); Andre Magras, Saint Gregoire (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/763,229

(22) Filed: Jun. 14, 2007

Related U.S. Application Data
(63) Continuation of application No. 10/411,726, filed on Apr. 11, 2003, now abandoned.

(30) Foreign Application Priority Data
Apr. 11, 2002 (FR) 02/04520

(51) Int. Cl. G06F 3/00

(52) U.S. Cl. 725/41

(57) ABSTRACT

The data stream constituting an electronic programme guide EPG containing video and/or audio previews is intended to be downloaded into a digital services decoder for television receiver. It comprises first header data blocks (DD,MC,SD) containing a directory of the data blocks of the stream, a routine intended for the decoder for the loading into memory and the running of the electronic programme guide in the decoder, and screen display parameters, and second data blocks (PD1,PD2,PD3) each containing a video and/or audio preview. The first header data blocks (DD,MC,SC) are repeated in the stream between the second data blocks (PD1,PD2,PD3) so as to improve the convenience of use of the EPG service.

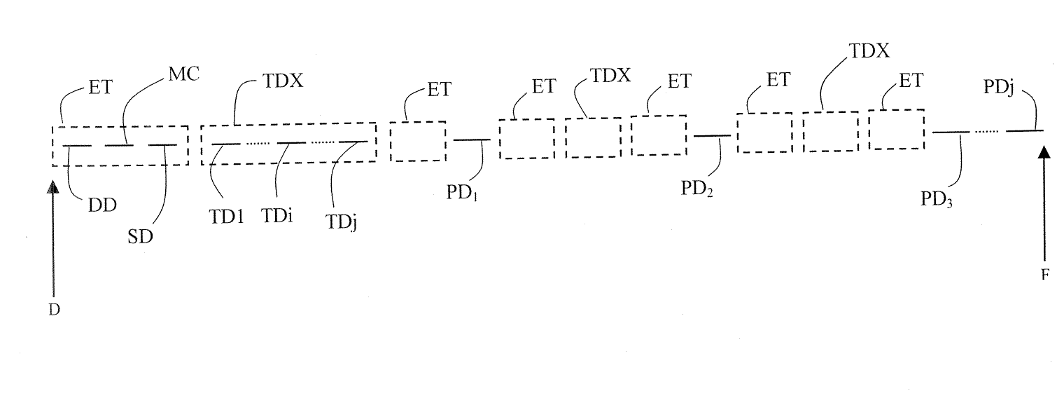

### BACKGROUND OF THE INVENTION

a) Field of the Invention

The invention relates to the transmission of a data stream constituting an electronic programme guide containing video and/or audio previews, and intended to be downloaded into a digital services decoder for television receiver in particular.

b) Background Art

The running of an electronic programme guide by the decoder provides on the screen of the television receiver, a programme grid in which various video and/or audio transmissions are chronologically listed in relation to the number of the station which broadcasts them. The user can thus scan the grid so as to display on the screen of his television receiver, the titles, descriptions and times of programming of the video and/or audio transmissions that he wishes to watch and/or to hear before switching his television receiver over to receive the corresponding station. An electronic programme guide containing video previews additionally allows the user to view for example a short extract of the video film referenced in the programme grid.

The patent documents US-A-5751282 and WO-98/26596 make reference to such an electronic programme guide called an EPG.

The data stream constituting an electronic programme guide is transmitted cyclically by a sender at a speed of around 3 Mb/s. It is generally refreshed daily. The time of a cycle corresponds to the transmission time of the data stream which is modulated on a carrier according to a carousel or an endless loop.

The data stream conventionally comprises, in this order, a so-called “Data Descriptor” data block, a so-called “Main Code” data block, a so-called “Screen Data” data block, a succession of so-called “Text Data” data blocks and a succession of so-called “Preview Data” data blocks. The “Data Descriptor” block contains a directory of the data blocks of the stream. The “Main Code” block contains a routine intended for the decoder for the loading into memory and the running of the electronic programme guide in the decoder. The “Screen Data” block contains screen display parameters for the display in particular of a wait screen and of the programme grid supplemented with the programme descriptions and previews. The “Text data” blocks each contain a textual description associated with a video and/or audio transmission referenced in the electronic programme guide. The “Preview Data” blocks each contain a video and/or audio preview associated with a video and/or audio transmission referenced in the electronic programme guide. The “Data Descriptor”, “Main Code” and “Screen Data” header blocks of the data stream generally occupy around 500 Kbytes and the “Text Data” blocks generally occupy around 1 Mbytes. The video and/or audio previews contained in the “Preview Data” blocks are generally compressed to the MPEG format. Despite this data compression format, a compressed video preview of 15 seconds for example represents a large amount of data to be transmitted that can be estimated at around 1 Mbytes minimum. As a result, the transmission cycle time of a data stream constituting an electronic programme guide containing some ten previews is of the order of 31 seconds, this possibly giving rise to considerable standby times for access to the EPG service by the user.

In particular, in response to a request for access to the EPG service by the user from a remote control of his television receiver, the decoder awaits the reception of the “Data Descriptor” block of a current data stream so as to subsequently retrieve the other data blocks which follow in the stream. Upon reception of the “Screen Data” block, a wait screen is generally presented on the television receiver to alert the user that his request for access to the EPG service has been taken into account. The programme grid is thereafter presented on the television receiver upon reception of the entire set of “Text Data” blocks, thereby allowing the user to scan the textual descriptions associated with the programme grid. A screen specific to the previews may be presented on the television receiver upon reception of the first or of the entire set of “Preview Data” blocks.

Since the loading of the electronic programme guide into the decoder must begin with the header blocks of the stream, it is understood that if the request for access to the EPG service by the user is made just prior to the transmission of the “Data Descriptor” block of a current data stream, the wait screen may be represented on the television receiver after a short waiting pause that can be estimated at around 1.5 seconds, this corresponding to the loading time of the header data blocks. On the other hand, if the user's request is made just after the transmission of the “Data Descriptor” block of a current stream, the waiting time for the display of the wait screen will be slightly greater than the duration of a transmission cycle of the data stream, that is to say around 32 seconds. Consequently, the mean waiting time for access to the EPG service by the user is around 17 seconds with a data stream containing some ten video and/or audio previews.

### SUMMARY OF THE INVENTION

The invention aims at solving the above-mentioned drawbacks of the prior art and proposes, according to a first aspect, a data stream constituting an electronic programme guide containing video and/or audio previews, and intended to be downloaded into a digital services decoder for television receiver. The data stream comprises first header data blocks containing a directory of the data blocks of the stream, a routine intended for the decoder for the loading into memory and the running of the electronic programme guide in the decoder, and screen display parameters. The data stream also comprises second data blocks each containing a video and/or audio preview. The first header data blocks are repeated in the stream between the second data blocks.

This structure of the data stream affords the decoder the possibility of downloading the header data blocks of the current stream even if the user has made his request for access to the EPG service during the transmission of this current stream. As a result, the user's mean waiting time to view the presentation of the wait screen of the electronic programme guide on his television receiver is thus decreased. The convenience of use of the EPG service is thereby improved without structurally modifying the decoder or increasing the speed of transmission of the data stream.

According to particular features of the data stream according to the invention, the first header data blocks are repeated each time in the stream between two second adjacent data blocks in the stream. The data stream comprises third data blocks containing a textual description of the programmes referenced in the electronic programme guide, the third data blocks together with the first header data blocks being repeated in the stream between the second data blocks. The third data blocks together with the first header data blocks are repeated each time between two second adjacent data blocks in the stream. The stream comprises a sequence consisting of the first header data blocks, of the third data blocks, of the first header data blocks, and of a second data block, this sequence being repeated in the stream as many times as there are second data blocks in the stream.

The invention also relates according to a second aspect to a method for transmitting a data stream constituting an electronic programme guide comprising video and/or audio previews, the stream having a structure as indicated hereinabove.

The invention also relates to a method for generating a programme grid in a decoder for display by a television receiver comprising the steps of: receiving in a decoder a data stream constituting an electronic programme guide and having a structure as described hereinabove and of generating a programme grid in the decoder, the programme grid containing firstly a textual description of the programmes if third data blocks have been received first by the decoder or containing firstly a video and/or audio preview if second data blocks have been received first by the decoder.

### BRIEF DESCRIPTION OF THE DRAWINGS

The invention will be even better understood on reading the description which follows of an exemplary structure of a data stream, illustrated by the single FIGURE.

### DETAILED DESCRIPTION OF EMBODIMENTS OF THE INVENTION

In the FIGURE, the data stream constituting an electronic programme guide comprises, in this order, a “Data Descriptor” data block denoted DD, a “Main Code” data block denoted MC, a “Screen Data” data block denoted SD. These three data blocks constitute the header data blocks and are together denoted by the reference ET. They are followed by several consecutive “Text Data” data blocks denoted TD1,TDi,TDj. Generally, a stream contains around 500 “Text Data” blocks. The entire set of “Text Data” blocks is denoted TDX. In the FIGURE, the references PD1,PD2,PD3,PDj denote “Preview Data” blocks. In the case of the example, the stream comprises some ten “Preview Data” blocks.

The size of the header blocks ET is estimated at 500 Kbytes. Each “Text Data” block occupies around 2 Kbytes so that the size of the entire set TDX of “Text Data” blocks is estimated at 1 Mbytes. The size of a “Preview Data” block is estimated at 1 Mbytes.

As visible in the FIGURE, the header blocks ET are repeated in the stream between the “Preview Data” blocks so as to allow the decoder to download the header blocks ET of a current stream even when the user makes a request for access to the EPG service during the transmission of this current stream. The time required for the presentation of the wait screen on the television receiver is thus reduced as compared with a stream structure where the “Preview Data” blocks are arranged consecutively one after the other.

Depending on the moment at which the user requests access to the EPG service, the decoder firstly receives “Text Data” blocks or “Preview Data” blocks and triggers the display on the screen of the television receiver of a programme guide in which a textual description of the events of the programme grid is posted first (if the decoder has received the “Text Data” blocks first) or else in which a preview of an event is posted first in the programme grid (if the decoder has received the “Preview Data” blocks first).

As visible in the FIGURE, the sequence situated at the beginning of the stream, consisting of the header blocks ET of the entire set TDX of “Text Data” blocks, of the header blocks ET and of a “Preview Data” block, is repeated in the stream as many times as there are “Preview Data” blocks in the stream. This structure makes it possible to obtain a mean waiting time for the presentation of the programme grid of the order of 8 seconds with a speed of transmission of the stream of the order of 3 Mb/s. With this stream structure, a preview contained in a “Preview Data” block can be available on the television receiver after a mean waiting time of the order of 8 seconds. The mean waiting time for the presentation of the wait screen on the television receiver is of the order of 3.5 seconds, this being identical to a data stream with no preview.

If instead of repeating the above sequence each time between two adjacent “Preview Data” blocks in the stream, only the header block ET is repeated, a preview may be available on the television receiver after a waiting time of the order of 6 seconds but the mean waiting time for the presentation of the programme grid is of the order of 24 seconds. The mean waiting time for the presentation of the wait screen on the television receiver is around 3.5 seconds.

In the FIGURE, the arrows D and F respectively indicate the beginning and the end of the data stream constituting the electronic programme guide which is downloaded into an integrated or nonintegrated digital decoder for television receiver or the like. As this stream is transmitted cyclically according to a carousel or an endless loop, with daily refreshing, the repetition in the current stream as indicated above of the header blocks ET and of the entire set of “Text Data” blocks does not introduce any particular difficulties of implementation at the level of the sender of the data stream. It will also be noted that the invention applies equally in the case of an independent decoder plugged into a television receiver as in the case of an integrated decoder built into a television receiver to form a digital television.

1. A video signal structure for video encoding, comprising: a data stream representative of an electronic program guide including at least one of: a video preview and an audio preview, and intended to be received by a decoder, the data stream having
first header blocks having a directory of the data blocks of the data stream, a routine intended for the decoder for the loading into memory and the ruining of the electronic program guide in the decoder, and screen display parameters, and
second blocks having said at least one of a video preview and audio preview, wherein the first header blocks are repeated in the data stream between the second blocks.

2. The video signal structure of claim 1, wherein the first header blocks are each time in the data stream between two second adjacent blocks in the data stream.

3. The video signal structure of claim 1, wherein said data stream further includes third blocks having a textual description of the programs referenced in the electronic program guide, and in which the third blocks together with the first header blocks are repeated in the data stream between the second blocks.

4. The video signal structure of claim 3, wherein the third blocks are positioned between two adjacent first header blocks such that the two first header blocks and the third block are repeated each time between two second adjacent blocks in the data stream.

5. The video signal structure of claim 3, wherein the data stream comprises a sequence made up of 1) the first header blocks, 2) the third blocks, 3) the first header blocks and 4) the second block, said sequence being repeated in the data stream as many times as there are second blocks in the data stream.

6. A method for transmitting a video signal structure for video encoding, comprising a data stream representative of an electronic program guide including at least one of: a video preview and an audio preview, and intended to be downloaded into a decoder, the data stream having
first header blocks containing a directory of the data blocks of the data stream, a routine intended for the decoder for the loading into memory and the running of the electronic program guide in the decoder, and screen display parameters, and
second blocks comprising information related to at least one of a video preview and an audio preview,
wherein the method comprises a step consisting in repeating in the data stream the first header blocks between the second blocks.

7. The method of claim 6, wherein the first header data blocks are repeated each time between two second adjacent data blocks in the stream

8. The method of claim 6, wherein the data stream further comprises third blocks containing a textual description of the programs referenced in the electronic program guide, the method further comprising a step of repeating in the data stream the third blocks together with the first header blocks between the second blocks.

9. The method of claim 8, wherein the third blocks together with the first header blocks are repeated each time between two second adjacent blocks in the data stream.

10. The method of claim 8, wherein a sequence of the data stream of: 1) the first header blocks, 2) the third blocks, 3) the first header blocks, and 4) a second block is repeated in the stream as many times as there are second blocks in the data stream.

11. A method for generating a program grid in a decoder for display by a television receiver comprising the steps of:
(a) receiving in a decoder a video signal structure comprising a data stream representative of an electronic program guide and having
first header blocks having a directory of the data blocks of the data stream, a routine intended for the decoder for the loading into memory and the running of the electronic program guide in the decoder, and screen display parameters;
second blocks having data corresponding to at least one of an video preview and an audio preview; and
third blocks having a textual description of the programs referenced in the electronic program guide, in which data stream the third blocks together with the first header blocks are repeated in the data stream between the second blocks, and
(b) generating a program grid in the decoder, the program grid having a textual description of the programs if third blocks have been received first by the decoder or said program grid having said at least one of a video preview and an audio preview a video and/or audio preview if said second blocks have been received first by the decoder.

12. A video signal structure for video encoding, comprising: a data stream representative of an electronic program guide that includes at least one of a video preview and an audio preview, and intended to be received by a decoder, the data stream having
first header blocks having a directory of the data blocks of the data stream, a routine intended for the decoder for the loading into memory and the running of the electronic program guide in the decoder, and screen display parameters, and
second blocks having data related to at least one of a video preview and an audio preview, wherein the first header blocks are repeated in the data stream between the second blocks.
